(19) United States
(12) Patent Application Publication
(10) Pub. No.: US 2023/0152129 A1
(43) Pub. Date: May 18, 2023

(54) Optical Encoder Assembly

(71) Applicant: Guangdong Ruixun Electronic Technology Co.,Ltd., Guangdong Province (CN)

(72) Inventor: Aihua CHEN, Guangdong Province (CN)

(21) Appl. No.: 17/618,423

(22) PCT Filed: Jan. 8, 2021
(86) PCT No.: PCT/CN2021/000007

§ 371 Date: Dec. 10, 2021

(30) Foreign Application Priority Data
Nov. 20, 2020 (CN) 202011314746.1

(51) Int. Cl. G01D 5/347

(52) U.S. Cl. CPC G01D 5/3473; G01D 5/34723

(57) ABSTRACT

The present invention discloses an optical encoder assembly composed of an encoder mechanical unit and a photoelectric unit, wherein the encoder mechanical unit comprises a base (1) and a cover (2), the photoelectric unit is a circuit board (4) mounted with an optical module (3), the optical module (3) including a light-emitting element (31) and a photosensitive element (32), the encoder mechanical unit is combined with the circuit board (4) as a photoelectric unit via the base (1), and the encoder mechanical unit cooperates with the photoelectric unit to generate photoelectric signals. This encoder adopts a light path module (51) with an innovative structure, and uses a light-blocking turntable (5) to cooperate with the light path module(51)to realize change of the light path. This structure ingeniously simplifies a light path switch module such that the structure is lighter and thinner, the layout is more reasonable. The present application has a compact structure, and-makes full use of space.

### BACKGROUND OF THE INVENTION

The present invention relates to an encoded signal output device, in particular to an optical encoder.

Rotary encoding switch is a common row of switches on the main board used as a jumper to adjust frequency, which is also called as an encoding switch or a DIP switch, outputting a binary BCD code.

The existing optical encoder generally adopts a grating structure, i.e., a light-emitting diode, two receiving tubes, and a grating of scrolling wheels therebetween. When the scrolling wheels are rolling, the grating continuously makes light blocked and transmitted, so that the receiving tubes obtain pulse signals to perceive the rolling effect of scrolling wheels. In order to obtain an operation with a smooth tactile, some mechanical structures are also required to achieve flipping tactile when rotating, but due to the addition of mechanical structures, the thickness of the product and its use will also be affected accordingly, and the overall structure will become complicated and difficult to use correspondingly.

### BRIEF SUMMARY OF THE INVENTION

In view of the above problems, the present invention aims to provide an optical encoder assembly with a novel structure.

In order to achieve this technical purpose, the solution of the present invention is: an optical encoder assembly composed of an encoder mechanical unit and a photoelectric unit, wherein the encoder mechanical unit comprises a base and a cover, and the photoelectric unit is a circuit board mounted with an optical module, the optical module including a light-emitting element and a photosensitive element, the encoder mechanical unit is combined with the circuit board as a photoelectric unit via the base, and the encoder mechanical unit cooperates with the photoelectric unit to generate photoelectric signals.

Preferably, the base of the encoder mechanical unit is provided with a light-blocking turntable that can freely rotate therein, the light-blocking turntable being mounted with a light path module at the bottom, and the base being provided with a light-transmitting hole at the bottom; and when the encoder mechanical unit is combined with the circuit board as a photoelectric unit via the base, the light-transmitting hole is corresponding to the light-emitting element.

Preferably, the light path module is several reflectors spaced uniformly at the bottom of the light-blocking turntable, a light-blocking structure is provided between the light-emitting element and the photosensitive element, and when the reflectors rotate to the light-transmitting hole, light emitted by the light-emitting element is refracted to the photosensitive element by the reflectors to receive light and thereby to generate signals.

Preferably, the light path module is several light guides uniformly spaced at the bottom of the light-blocking turntable, the photosensitive element is arranged on a side of the light guides and mounted on the circuit board, and when the light guides rotate to the light-transmitting hole, light emitted by the light-emitting element is transmitted to the photosensitive element by the light guides to receive light and thereby to generate signals.

Preferably, there are two photosensitive elements, and the photosensitive elements are arranged side by side with each other.

Preferably, the light-blocking turntable is provided with a groove matching with the light path module at the bottom, and the light path module is embedded in the groove.

Preferably, the base is provided with a through hole, and the light-blocking turntable is inserted into the through hole through a rotating shaft to be fastened to the base.

Preferably, the photoelectric unit is designed in separation of the encoder mechanical unit, and the photoelectric unit is covered with a light-transmitting waterproof insulating protective layer.

Preferably, the top surface of the light-blocking turntable is a concave-convex surface with a concave portion and a convex portion uniformly spaced, and the encoder mechanical unit is further provided with an elastic member matching with the concave-convex surface to provide flipping tactile.

Preferably, the elastic member comprises a fixing plate and an elastic rod disposed on the fixing plate, and the elastic rod is provided in the middle with an elastic protrusion abutting the concave-convex surface of the light-blocking turntable, when the light-blocking turntable is rotated, the elastic protrusion cooperates with the concave-convex surface to provide flipping tactile; and the fixing plate is fixed on the base.

The beneficial effects of the present invention are: this encoder adopts a light path module with an innovative structure, and uses a light-blocking turntable to cooperate with the light path module to realize change of the light path; this structure ingeniously simplifies a light path switch module such that the structure is lighter and thinner, the layout is more reasonable, and meanwhile, the cost is saved; in addition, the light-blocking turntable is further provided with a concave-convex surface, which can cooperate with an elastic member to provide users flipping tactile; and the present application has a compact structure, makes full use of space, is convenient to use, and thus is suitable for mass production.

### BRIEF DESCRIPTION OF THE DRAWINGS

FIG. 1 is a structure diagram of the present invention:

FIG. 2 is an exploded diagram of the present invention;

FIG. 3 is a structure diagram of an embodiment of a light guide of the present invention;

FIG. 4 is an exploded diagram of an embodiment of a light guide of the present invention;

FIG. 5 is a structure diagram of an elastic member of the present invention;

FIG. 6 is a structure diagram of a light-blocking turntable of the present invention;

FIG. 7 is a structure diagram of a base of the present invention;

FIG. 8 is a structure diagram of an optical module of the present invention,

1. Base; 11. Light-transmitting hole; 12. Through hole; 2 Cover; 3. Optical module; 31. Light-emitting element; 32. Photosensitive element; 33. Light-blocking structure; 34. Waterproof insulating protective layer; 4. Circuit board; 5. Light-blocking turntable; 51. Light path module (reflector/light guide); 52. Groove; 53. Arc bump; 6. Elastic member; 61. Fixing plate; 62. Elastic rod; 63. Elastic protrusion.

### DETAILED DESCRIPTION OF THE INVENTION

The present invention will be further elaborated below in combination with the drawings and specific embodiments.

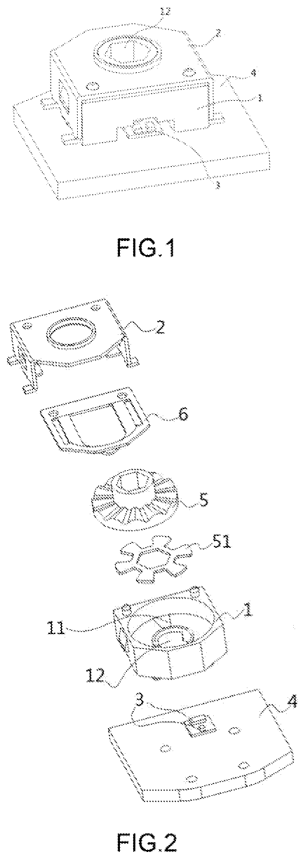

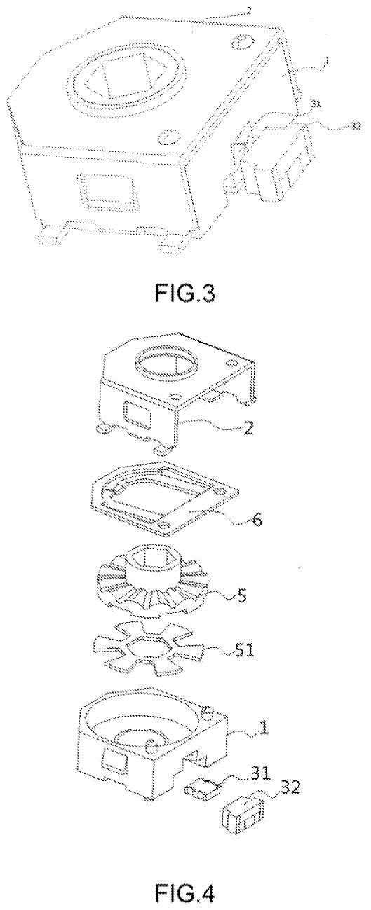

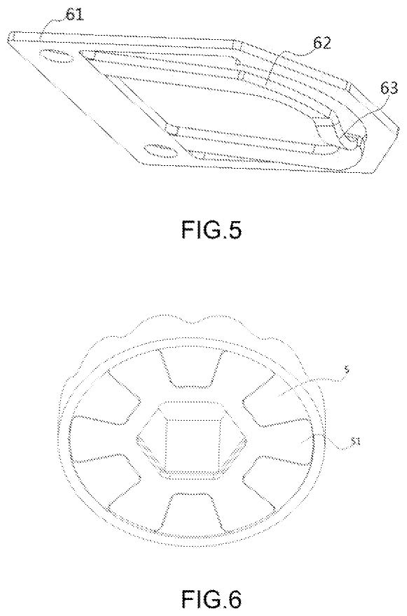

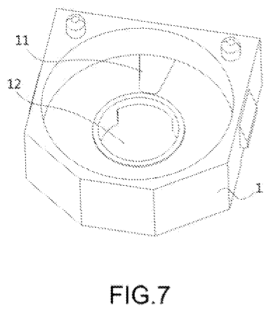

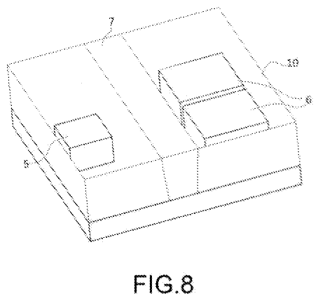

As shown in FIGS. 1-8, the specific embodiment of the present invention is an optical encoder assembly composed of an encoder mechanical unit and a photoelectric unit, wherein the encoder mechanical unit comprises a base 1 and a cover 2, and the photoelectric unit is a circuit board 4 mounted with an optical module 3, the optical module 3 including a light-emitting element 31 and a photosensitive element 32, the encoder mechanical unit is combined with the circuit board 4 as a photoelectric unit via the base 1, and the both cooperate to realize output of photoelectric signals, the photoelectric unit is designed in separation of the mechanical unit, and the photoelectric unit is covered with a waterproof insulating protective layer 34 such that the encoder assembly is dustproof, waterproof and antistatic.

The base 1 of this encoder mechanical unit is provided with a light-blocking turntable 5 that can freely rotate therein, the bottom of the light-blocking turntable is made of a non-reflective material, the base 1 is provided with a through hole 12, and the light-blocking turntable 5 is inserted into the through hole 12 through a rotating shaft to be fastened to the base 1. The light-blocking turntable 5 is mounted with a light path module 51 at the bottom, and the base 1 is provided with a light-transmitting hole 11 at the bottom; and when the encoder mechanical unit is combined with the circuit board 4 as a photoelectric unit via the base 1, the light-transmitting hole 11 is corresponding to the light-emitting element 31.

The light path module may be reflectors or light guides. When the light path module 51 is several reflectors spaced uniformly at the bottom of the light-blocking turntable 5, a light-blocking structure 33 is provided between the light-emitting element 31 and the photosensitive element 32, and when the reflectors rotate to the light-transmitting hole 11, light emitted by the light-emitting element 31 is refracted to the photosensitive element 32 by the reflectors to receive light and thereby to generate signals.

When the light path module 51 is several light guides uniformly spaced at the bottom of the light-blocking turntable, the photosensitive element 32 is arranged on a side of the light guides and mounted on the circuit board 4, and when the light guides rotate to the light-transmitting hole 11, light emitted by the light-emitting element 31 is transmitted to the photosensitive element 32 by the light guides to receive light and thereby to generate signals.

There are two photosensitive elements 32, which are arranged side by side with each other, such that the encoder is capable of generating displacement signals. After the light emitted by the light-emitting element arrives at the light path module 51, the light as refracted or derived comes to one of the photosensitive elements first, and then to the other. By means of forward and reverse rotation, the light emitted by the light-emitting element reaches the two photosensitive elements 32 in different orders and provides different direction signals. In addition, according to the speed of rotation, it is possible to distinguish how many grids the light-blocking turntable rotates; and provide different displacement signals.

In order to make the encoder structure lighter and thinner, the light-blocking turntable 5 is provided with a groove 52 matching with the light path module at the bottom, the light path module 51 is embedded in the groove 52, and when the light path module 51 rotates to the light-transmitting hole 11 the optical module 3 outputs light path signals.

In order to make the encoder assembly feel better when in use, the top surface of the light-blocking turntable 5 is a concave-convex surface 53 with a concave portion and a convex portion uniformly spaced, and the encoder mechanical unit is further provided with an elastic member 6 matching with the concave-convex surface 53 to provide flipping tactile.

This elastic member 6 comprises a fixing plate 61 and an elastic rod 62 disposed on the fixing plate 61, the elastic rod and the fixing plate being arranged integrally; the elastic rod 62 is provided in the middle with an elastic protrusion 63 abutting the concave-convex surface 53 of the light-blocking turntable, and when rotating the light-blocking turntable 5, the elastic protrusion 63 cooperates with the concave-convex surface 53 to provide flipping tactile; in order to make the fixing plate more tightly coupled, the fixing plate 61 and the cover 2 are provided with corresponding fixing holes, by combining the fixing holes with fixing posts on the base, the elastic member 6 and the cover 2 can be maintained stably. Additionally, the cover is provided with fixing feet extending from the bottom, which are welded on the bottom plate to keep the overall structure stable.

This encoder adopts a light path module with an innovative structure, and uses a light-blocking turntable to cooperate with the light path module to realize change of the light path. This structure ingeniously simplifies a light path switch module such that the structure is lighter and thinner, the layout is more reasonable, and meanwhile, the cost is saved. In addition, the light-blocking turntable is further provided with a concave-convex surface, which can cooperate with an elastic member to provide users flipping tactile. The present application has a compact structure, makes full use of space, is convenient to use, and thus is suitable for mass production.

The above are only preferred embodiments of the present invention and never serve to limit the present invention. Any minor modifications, equivalent substitutions, and improvements that are made to the above embodiments on the basis of the technical essence of the present invention shall fall within the scope of protection of the technical solution of the present invention.

1. An optical encoder assembly composed of an encoder mechanical unit and a photoelectric unit, wherein the encoder mechanical unit comprises a base and a cover, and the photoelectric unit is a circuit board mounted with an optical module, the optical module including a light-emitting element and a photosensitive element, characterized in that the encoder mechanical unit is combined with the circuit board as a photoelectric unit via the base, and the encoder mechanical unit cooperates with the photoelectric unit to generate photoelectric signals; the base of the encoder mechanical unit is provided with a light-blocking turntable that can freely rotate therein, the light-blocking turntable being mounted with a light path module at the bottom, and the base being provided with a light-transmitting hole at the bottom; and when the encoder mechanical unit is combined with the circuit board as a photoelectric unit via the base, the light-transmitting hole is corresponding to the light-emitting cement the light path nodule is several reflectors spaced uniformly at the bottom of the light-blocking turntable, there are two photosensitive elements arranged side by side with each other, a light-blocking structure is provided between the light-emitting element and the photosensitive element, and when the reflectors rotate to the light-transmitting hole, light emitted by the light-emitting element is refracted to the photosensitive element by the reflectors to receive light and thereby to generate signals.

2. The optical encoder assembly according to claim 1, characterized in that the light-blocking turntable is provided with a groove matching with the light path module at the bottom, and the light path module is embedded in the groove.

3. The optical encoder assembly according to claim 1, characterized in that the base is provided with a through hole, and the light-blocking turntable is inserted into the through hole through a rotating shaft to be fastened to the base.

4. The optical encoder assembly according to claim 1, characterized in that the photoelectric unit is designed in separation of the encoder mechanical unit, and the photoelectric unit is covered with a light-transmitting waterproof insulating protective layer.

5. The optical encoder assembly according to claim 2, characterized in that the top surface of the light-blocking turntable is a concave-convex surface with a concave portion and a convex portion uniformly spaced, and the encoder mechanical unit is further provided with an elastic member matching with the concave-convex surface to provide flipping tactile.

6. The optical encoder assembly according to claim 5, characterized in that the elastic member comprises a fixing plate and an elastic rod disposed on the fixing plate, and the elastic rod is provided in the middle with an elastic protrusion abutting the concave-convex surface of the light-blocking turntable, when the light-blocking turntable is rotated, the elastic protrusion cooperates with the concave-convex surface to provide flipping tactile; and the fixing plate is fixed on the base.

7. (canceled)

8. (canceled)

9. (canceled)

10. (canceled)
